(19) United States
(12) Patent Application Publication
(10) Pub. No.: US 2006/0180323 A1
(43) Pub. Date: Aug. 17, 2006

(54) Construction apparatus

(76) Inventor: Erwin Stoetzer, Aichach (DE)

Correspondence Address: JACOBSON HOLMAN PLLC, 400 SEVENTH STREET N.W., SUITE 600, WASHINGTON, DC, 20004, US

(21) Appl. No.: 11/263,996

(22) Filed: Nov. 2, 2005

(30) Foreign Application Priority Data
Nov. 8, 2004 (EP) 04 026 489.7

(51) Int. Cl. A01B 63/00

(52) U.S. Cl. 172/42

(57) ABSTRACT

The invention relates to a construction apparatus comprising a carriage, a mast element and a pivot device having a hinge, on which the mast element is supported in a transversely pivotable manner on the carriage. In the construction apparatus the hinge is arranged on the mast element in a portion which is spaced from the base of the mast element.

### CONSTRUCTION APPARATUS

The invention relates to a construction apparatus comprising a carriage, a mast element and a pivot device having a hinge, on which the mast element is pivotally supported on the carriage in a transverse direction to a longitudinal plane of the carriage.

A construction apparatus according to the preamble can be taken from DE 44 36 264 C1. The construction apparatus known from this printed publication has a two-part mast comprising an upper and a lower mast element, which are locked in an aligned working position when the mast is located in a vertical operating position. For the transverse pivoting of the mast a tubular boom is provided on the ground-facing end of the lower mast element. Together with the inner surface of a sleeve-shaped receiving part provided on the carriage of the construction apparatus the outer surface of the boom forms a sliding fit. As a result, a support of the mast on the carriage is provided in a sliding manner along the centre axis of the receiving part and in a rotating manner about the said centre axis for the transverse pivoting motion.

The object of the invention is to provide a construction apparatus according to the preamble that possesses a particularly high reliability.

The object is solved in accordance with the invention by a construction apparatus having the features of claim 1. Preferred embodiments are stated in the dependent claims.

The construction apparatus according to the invention is characterized in that the hinge is arranged on the mast element in a portion which is spaced from the base of the mast element.

A fundamental idea of the invention may be seen in the fact that for the transverse pivoting of the mast element the hinge is not provided directly on the mast base but is offset upwards on the mast with respect to the mast base. According to the invention the mast therefore projects from underneath the hinge. As a result, it is possible to arrange a guiding device for a soil working implement that is provided on the mast, such as a power rotary head, below the hinge in direct vicinity to the soil to be worked on, whereby a particularly twist-free and therefore reliable operation of the soil working implement of the construction apparatus is rendered possible. Owing to the arrangement of the hinge above the mast base in accordance with the invention, the hinge is at the same time protected from mechanical effects and contamination that frequently occurs during the operation of the construction apparatus in the direct vicinity of the soil surface, so that the reliability of the construction apparatus is increased further. Moreover, in a construction apparatus according to the invention the torques required for the transverse pivoting of the mast are particularly low, especially if the guiding device, for instance the power rotary head, is positioned below the hinge.

In principle, the construction apparatus according to the invention can be designed with a one-piece mast or a mast comprised of multiple pieces, with only one mast element being provided in the case of a one-piece mast. In addition, according to the invention at least one boom may be provided on the mast head that is preferably pivotable in the longitudinal plane of the carriage in order to pivot a cable guide pulley. Within the meaning of the invention the longitudinal plane of the carriage can be understood more particularly as a plane extending perpendicularly to the carriage base from the rear to the front of the carriage.

According to the invention it is of advantage that a drive device is arranged for the active pivoting of the mast element in a transverse direction to the longitudinal plane. It is particularly preferred that for the active transverse pivoting of the mast element at least one pivotal linear drive, in particular a hydraulic pivot cylinder, is provided which is hinged on its one side to the mast element in the portion of the base of the mast element and on its other side to the carriage in particular. According to this embodiment, through which a particularly compact construction apparatus can be achieved, the pivotal linear drive is therefore arranged on its one side on the mast element below the hinge. Advantageously, the pivot cylinder is designed as a bilaterally operating cylinder. However, the pivotal linear drive can also be designed as a spindle drive or a rack-and-pinion drive for example.

In principle, it is possible to provide the pivotal linear drive with any chosen alignment with respect to the mast element. For particularly low drive forces the pivotal linear drive can be arranged orthogonally to the mast element for example. Other angular arrangements are possible, too. However, it is particularly preferred that the pivotal linear drive extends at least approximately parallel to the mast element. Through this the external dimensions of the construction apparatus can be reduced further. By the parallel arrangement of the pivotal linear drive to the mast element it can be understood here in particular that the drive direction of the linear drive extends parallel to the mast element. If the pivotal linear drive is designed as a hydraulic pivot cylinder, the parallel arrangement can be understood in that the longitudinal axis of the pivot cylinder extends parallel to the mast element. The arrangement of the pivotal linear drive with respect to the mast element can change upon a transverse pivoting of the mast element. Preferably, the at least approximately parallel arrangement of the pivotal linear drive with respect to the mast element is present, at least when the mast element is not pivoted in the transverse direction, i.e. when it extends in the longitudinal plane.

Basically, the pivotal linear drive can be arranged in any chosen manner on the mast element in the portion of the mast base. However, it is particularly preferred that on the base of the mast element a yoke extending transversely to the mast element is provided, to which the pivotal linear drive is hinged. In this case the mast element is therefore designed in its base portion with a widening, on which the pivotal linear drive is provided. In order to achieve sufficiently high torques for the pivoting of the mast element, whilst having a particularly simple construction, it is advantageous for one longitudinal side of the yoke to be aligned with the underside of the mast element. Preferably, the yoke is designed as a sheet metal that can have a tapering towards the outside. Advantageously, the yoke is arranged on a longitudinal side of the mast element facing towards the carriage.

Basically, for the active transverse pivoting of the mast element a single pivotal linear drive can merely be provided which can in particular be operated bilaterally. However, it is particularly preferred that at least one pivotal linear drive each is provided on both sides of the mast element. Hence, according to this embodiment at least two pivotal linear drives are provided that are counteracting. It is also possible for further pivotal linear drives to be provided. When seen in the front view of the carriage, i.e. in the longitudinal direction of the carriage, the at least one pivotal linear drive is suitably arranged beside the mast element. Advantageously, the at least one pivotal linear drive is provided between a carriage-facing longitudinal side of the mast element and the carriage.

In accordance with the invention a construction apparatus having a particularly simple design is provided in that the hinge has two coaxial surfaces, in particular cylinder surfaces. Here, it is of particular preference that an inner one of the two surfaces is arranged on the carriage, while an outer one of the two surfaces is arranged on the mast element. Alternatively, the outer one of the two surfaces can be arranged on the carriage and the inner one can be arranged on the mast element. The hinge may include for example a sleeve that comprises a bolt. The sleeve is preferably provided on the carriage and the bolt is provided on the mast element. The sleeve can also be provided on the mast element while the bolt is provided on the carriage. The sleeve can also be designed in an intermittent manner.

To further increase the reliability of the construction apparatus, the hinge can have a blocking device by means of which the mast element can be blocked against a transverse pivoting motion. For this purpose the blocking device can have e.g. a gear ring, into which at least one gear element is inserted for the blocking. As an alternative or in addition to such a form-locking blocking device a force-locking blocking device may also be provided.

The compactness of the construction apparatus according to the invention can be increased further in that the hinge is arranged, preferably in its entirety, on the mast element in a rear-offset manner with respect to a longitudinal side of the mast element facing towards the carriage. Hence, according to this embodiment the hinge is not spaced from the mast element but engages at least partly in the mast element on the longitudinal side. More particularly, the two surfaces of the hinge can be arranged on the mast element in a rear-offset manner with respect to the longitudinal side of the mast element facing towards the carriage. The longitudinal side of the mast element that faces towards the carriage suitably constitutes at the same time the longitudinal side of the mast element that faces away from the power rotary head and/or the drilling tool. A longitudinal side of the mast element can be understood in particular as a side extending from the head to the base of the mast element.

In order to achieve a particularly reliable transverse pivoting of the mast element it is of advantage that two neck-type linear drives, in particular two hydraulic neck cylinders, are provided which are each hinged on their one side to the carriage and on their other side to the mast element above the hinge. Advantageously, the neck-type linear drives are provided in addition to the pivotal linear drives, in which case a torque for the transverse pivoting motion can be applied to the mast element both above and below the pivot joint. While it is of advantage that the at least one pivotal linear drive is pivotally hinged to the mast element and/or to the carriage about a rotational axis that extends at least approximately parallel to the longitudinal plane, the neck-type linear drives are preferably pivotally hinged to the mast element and/or to the carriage about rotational axes that extend at least approximately perpendicularly to the longitudinal plane. It is suitable for the neck-type linear drives not to extend parallel to the mast element, so that by means of these neck-type linear drives an active pivoting of the mast element in the longitudinal plane is rendered possible, too. The two neck-type linear drives are suitably arranged on both sides of the mast element. By preference, a control device is provided which coordinates the movement of the pivotal linear drives and the neck-type linear drives.

In accordance with the invention a particularly compact construction apparatus is provided in that the two neck-type linear drives are arranged at least approximately parallel to each other.

According to the invention a particularly versatile construction apparatus is characterized in that between the hinge and the carriage a further hinge is provided for the longitudinal pivoting of the mast element. By longitudinal pivoting a pivoting movement in the longitudinal plane of the carriage can be understood. It is of advantage for the rotational axes of the two hinges to extend at least approximately perpendicularly to each other and they can also intersect for a particularly compact construction apparatus.

A construction apparatus of a particularly simple and compact design is characterized in that the further hinge has a hinge axis arranged on the carriage and that the pivotal linear drive is hinged to the hinge axis. Advantageously, the hinge axis protrudes laterally from the hinge at least on one side of the mast element, in which case the pivotal linear drive can then be mounted on this protruding portion.

For the transverse pivoting of the mast element a square arrangement is preferably provided, with two opposite, length-adjustable sides of the square being constituted by the two pivotal linear drives and two further sides of fixed length being constituted by the hinge axis and the yoke in particular. By changing the length of the two pivotal linear drives the angular position. of the yoke is changed with respect to the hinge axis located on the carriage and consequently also the angular position of the mast element arranged on the yoke with respect to the carriage.

In accordance with the invention a particularly compact and versatile construction apparatus resides in that a displacement device is provided, by means of which at least one of the two hinges is supported in a longitudinally displaceable manner on the carriage. In particular, the displacement device can have a slide which is provided on the carriage by being guided in a longitudinally displaceable manner and on which are arranged at least the hinge for the transverse pivoting or the longitudinal pivoting, but preferably both hinges. By preference, the displacement device includes an operating drive for actively displacing the at least one hinge.

In the following the invention is described in greater detail by way of preferred embodiments schematically shown in the Figures, wherein:

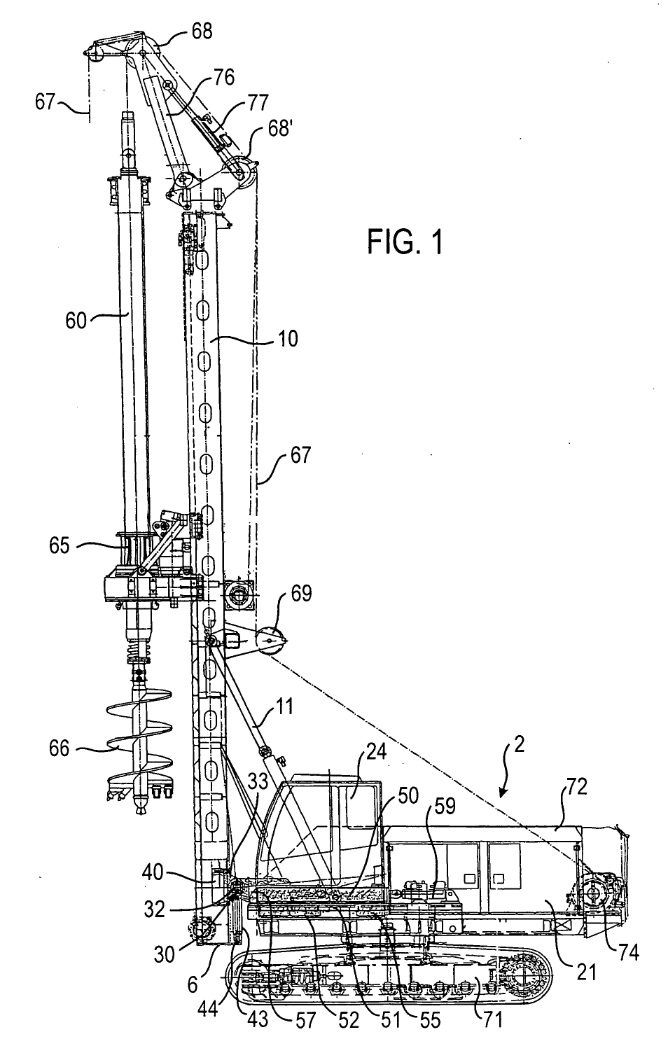

FIG. 1 shows a lateral view of the construction apparatus according to the invention, in which the mast element is located in an approximately vertical operating position;

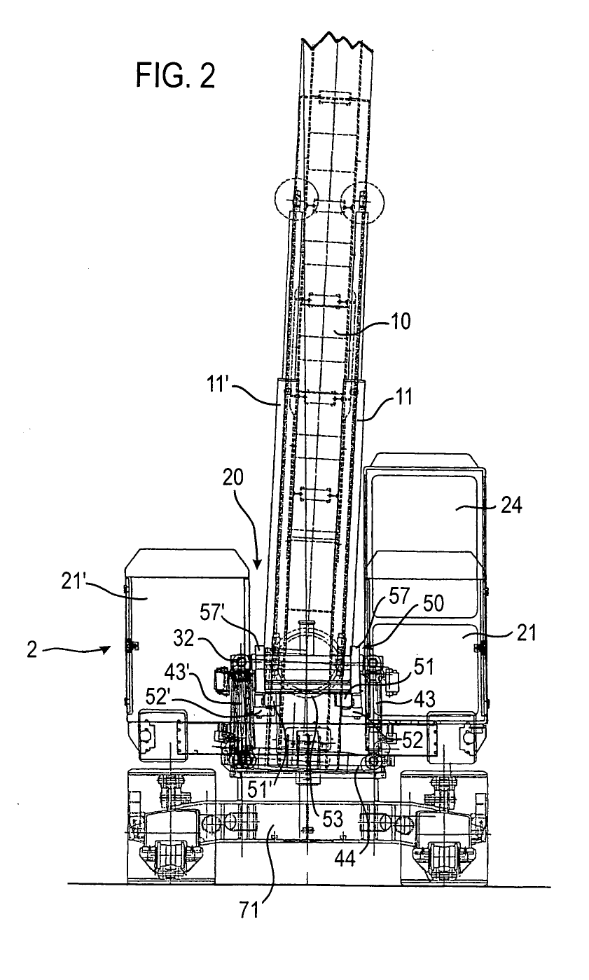

FIG. 2 shows a front view of the construction apparatus of FIG. 1 without drilling tool, drilling rod or power rotary head and with the mast element located in the operating position, and here, for the purpose of drilling in an inclined manner, the mast element is pivoted transversely to a longitudinal plane and is illustrated in broken lines in its upper portion; and

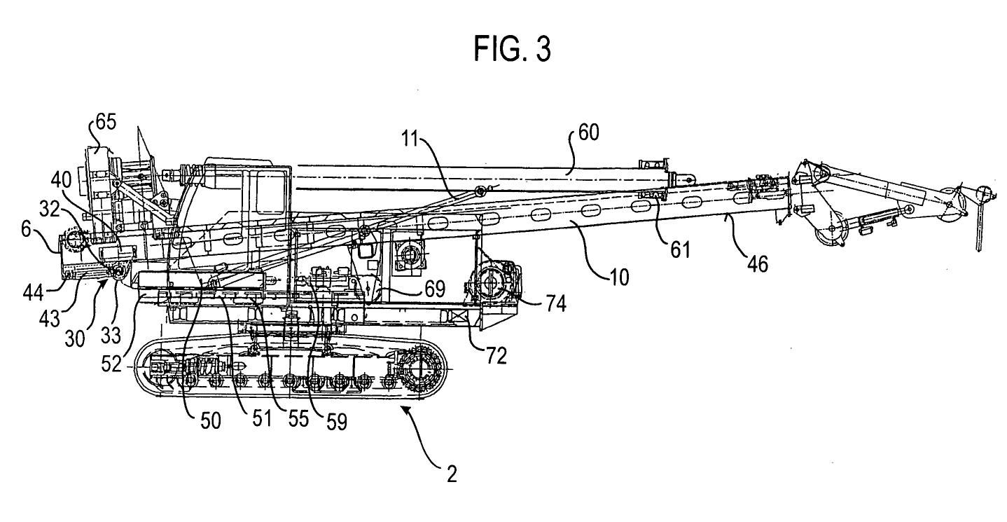

FIG. 3 shows a lateral view of the construction apparatus of FIG. 1 in its transport condition, in which the mast element is pivoted into its transport position.

A construction apparatus according to the invention is illustrated in FIGS. 1 to 3. The construction apparatus has a carriage 2 comprising a lower carriage 71 designed as a crawler running gear and an upper carriage 72 rotatably supported on the latter. A mast element 10 is hinged to the upper carriage 72 of the carriage 2 pivotable in the longitudinal plane thereof. In the illustrations of FIGS. 1 and 2 the mast element 10 is located in an operating position, in which the mast element 10 extends approximately in the vertical direction. In the illustration of FIG. 3, however, the mast element 10 is shown in a transport position, in which the mast element 10 is pivoted in the longitudinal plane of the upper carriage 72 such that it extends backwards beyond the carriage 2.

In order to pivot the mast element 10 longitudinally, i.e. to pivot the mast element 10 in the longitudinal plane of the upper carriage 72, a hinge 30 is provided on the ground-facing side of the mast element 10. This hinge 30 has a hinge axis 32 that extends horizontally and transversely to the longitudinal plane and two hinge bearing plates 33 that protrude longitudinally from the mast element 10 and through which the hinge axis extends. The hinge bearing plates 33 are arranged above the base 6 of the mast element 10.

The hinge axis 32 of the hinge 30 is arranged on a slide 50 guided in a longitudinally displaceable manner on the upper carriage 72. To this end, provided on the upper carriage 72 are two guide rails 51, 51′ extending parallel and longitudinally to the upper carriage 72, which are embraced laterally and from below, i.e. from the ground-facing side, by a respective front guide skid 52, 52′ of the slide 50 that has an L-shaped cross-sectional profile. Above the two front guide skids 52, 52′ the slide 50 has a transversely extending yoke 53, which connects the two front guide skids 52, 52′. This yoke 53 rests on the upper side of the guide rails 51, 51′. In addition to the two front guide skids 52, 52′ and spaced therefrom the slide 50 has two rear guide skids 55 that are equally designed with an L-shaped cross-sectional profile and embrace the guide rails 51, 51′. The terms “front” and “rear” can be understood here in relation to the hinge 30, i.e. the front guide skids 52, 52′ are arranged closer to the hinge 30 than the rear guide skids 55. The rear guide skids 55 are likewise connected to each other by a transversely extending yoke. As a result of the guide skids 52, 52′, 55 and the yokes connecting these skids, the slide 50 is guided on the carriage 2 in a rotationally fixed manner whilst being displaceable solely in the longitudinal direction and parallel to the guide rails 51, 51′.

At the front of the slide 50 two vertically extending retaining plates 57 are provided, through which the hinge axis 32 extends in particular in a rotational manner. For the active displacement of the slide 50 a hydraulic operating cylinder 59 is arranged in the rear of the said slide, which is in turn arranged on the upper carriage 72. In FIG. 3 the piston rod of the operating cylinder 59 is depicted as being detached from the slide 50.

Through the slide 50 it is possible to horizontally displace the hinge 30 and consequently the lower portion of the mast element 10 with respect to the upper carriage 72 of the carriage 2. In particular, as depicted in FIG. 3, the slide 50 can be displaced forwards on the upper carriage 72 together with the hinge 30 in order to transport the construction apparatus. As a result, it is possible to increase the maximum pivoting angle of the mast element 10, i.e. the maximum angle of the mast element 10 with respect to the vertical. This maximum pivoting angle can in particular be defined by an obstruction located in the rear of the upper carriage 72, such as a cable winch 74, which limits the pivotal motion path of the mast element 10. Through a forward displacement of the hinge 30 by means of the slide 50 the distance of the hinge 30 to this obstruction is enlarged and the maximum possible pivoting angle is thereby increased.

As can be taken from FIG. 1, however, the slide 50 is retracted during the operation of the construction apparatus and the centre of gravity of the mast element 10 is thereby displaced closer to the centre of gravity of the carriage 2 so as to increase the tilt resistance.

As shown in FIG. 1 the construction apparatus according to the invention can be employed for the operation of a soil working implement 66 designed as an auger in the illustrated embodiment. This soil working implement 66 is arranged on the ground-facing side of a telescopic drill rod 60, which is longitudinally guided and rotatably drivable on the mast element 10 by means of a power rotary head 65. In operation the drill rod 60 is suspended on its upper side on a cable 67 that is guided via two guide pulleys 68, 68′ arranged on the head of the mast element 10 and a guide pulley 69 arranged longitudinally on the mast element 10 to the cable winch 74 located in the rear of the upper carriage 72. While the rear guide pulley 68′ of the two guide pulleys located on the mast head is supported in a stationary manner on the head of the mast element 10, the front guide pulley 68 is pivotally supported on the mast element 10 by means of a boom 76. For the active pivoting of the boom 76 with the front guide pulley 68 a linear drive 77 is provided.

In the operating condition depicted in FIG. 1 the front guide pulley 68 is pivoted forwards into an aligned position with the drill rod 60. In contrast to this, in the transport condition depicted in FIG. 3 it is pivoted backwards through a retraction of the linear drive 77, as a result of which the vertical clearance of the construction apparatus is reduced.

As can furthermore be taken from FIG. 3, in order to achieve a further reduction of the vertical clearance of the construction apparatus in its transport position the drill rod 60 can be removed from the longitudinally guiding power rotary head 65, detached from the cable 67 and can be placed on a support 61 provided in the upper portion of the mast element 10.

As can be gathered from FIG. 2 in particular, the upper carriage 72 has in its center a recess 20 which extends longitudinally of the upper carriage 72 and into which the mast element 10 is placed in its transport position. On both sides of the recess 20 a hydraulic power pack 21, 21′ is each provided for the generation of hydraulic pressure. In front of the power pack 21 on the left side and laterally adjacent to the power pack 21′ an operator's cabin 24 is additionally provided on the upper carriage 72.

For the active longitudinal pivoting of the mast element 10, in particular between its operating position and its transport position, two parallel extending neck cylinders 11, 11′ are provided, which are each hinged on their one side to the mast element 10 and on their other side to the slide 50. Alternatively, the neck cylinders 11, 11′ can also be hinged to a stationary part of the upper carriage 72. However, since the neck cylinders 11, 11′ are hinged to the slide 50, the longitudinal pivoting of the mast element 10 is independent of the position of the slide 50 on the upper carriage 72.

As can more particularly be taken from FIG. 2, in addition to being supported in a longitudinally pivotable manner by means of the hinge 30, the mast element 10 is also provided in a transversely pivotable manner on the upper carriage 72. In this context the transverse pivoting is understood as a pivoting motion transversely to the longitudinal plane of the upper carriage 72. For the transversely pivotable support of the mast element 10 on the upper carriage 72 a further hinge 40 is provided on the hinge bearing plates 33 of the hinge 30, the rotational axis of which is arranged perpendicularly to the rotational axis of the hinge 30. This hinge 40 is constituted by a bolt formed on the hinge bearing plates 33 which engages into a sleeve located on the mast element 10. Alternatively, the sleeve can also be formed on the hinge bearing plates 33 and the bolt can be formed on the mast element 10. Just as the hinge 30 the hinge 40 located directly adjacent thereto is also spaced from the base 6 of the mast element 10. For a particularly compact construction the hinge 40 is arranged in a rear-offset manner towards the inside of the mast element 10 with respect to the longitudinal side 46 of the mast element 10 facing towards the carriage. As can furthermore be gathered from FIG. 2 in particular, for the active transverse pivoting of the mast element 10 about the hinge 40 a pivotal linear drive designed as a hydraulic pivot cylinder 43, 43′ is respectively provided on both sides of the mast element 10. In FIG. 2 the pivot cylinder 43 is shown in different pivoting conditions. The two pivot cylinders 43, 43′ are each arranged, more particularly hinged on their one side to the hinge axis 32 of the hinge 30 and on their other side to a yoke 44 located on the base of the mast element 10 and extending transversely thereto. The rotational axes of these hinges extend at least approximately parallel to the rotational axis of the hinge 40. By operating the two pivot cylinders 43, 43′ in opposite directions the yoke 44 and consequently the mast element 10 connected therewith is pivoted transversely with respect to the hinge bearing plates 33 and consequently the upper carriage 72. Just as the two pivot cylinders 43, 43′ the two neck cylinders 11, 11′ are also arranged parallel to each other, as a result of which two hinge points of the neck cylinders 11, 11′ are present on the mast element 10. In order to promote the active transverse pivoting of the mast element 10 the two neck cylinders 11, 11′ are likewise displaced in opposite directions in synchronization with the counter-directed operation of the two pivot cylinders 43, 43′.

1. Construction apparatus comprising
a carriage,
a mast element and
a pivot device having a hinge, on which the mast element is pivotally supported on the carriage in a transverse direction to a longitudinal plane of the carriage, wherein
the hinge is arranged on the mast element in a portion which is spaced from the base of the mast element.

2. Construction apparatus according to claim 1, wherein
for the active transverse pivoting of the mast element at least one pivotal linear drive, in particular a hydraulic pivot cylinder, is provided which is hinged on its one side to the mast element in the portion of the base of the mast element and on its other side to the carriage.

3. Construction apparatus according to claim 2, wherein
the pivotal linear drive extends at least approximately parallel to the mast element.

4. Construction apparatus according to claim 2, wherein
on the base of the mast element a yoke extending transversely to the mast element is provided, to which the pivotal linear drive is hinged.

5. Construction apparatus according to claim 2, wherein
at least one pivotal linear drive each is provided on both sides of the mast element.

6. Construction apparatus according to claim 1, wherein
the hinge is arranged, preferably in its entirety, on the mast element in a rear-offset manner with respect to a longitudinal side of the mast element facing towards the carriage.

7. Construction apparatus according to claim 1, wherein
two neck-type linear drives, in particular two hydraulic neck cylinders, are provided which are each hinged on their one side to the carriage and on their other side to the mast element above the hinge.

8. Construction apparatus according to claim 7, wherein
the two neck-type linear drives are arranged at least approximately parallel to each other.

9. Construction apparatus according to claim 1, wherein
between the hinge and the carriage a further hinge is provided for the longitudinal pivoting of the mast element.

10. Construction apparatus according to claim 9, wherein
the further hinge has a hinge axis arranged on the carriage, and
the pivotal linear drive is hinged to the hinge axis.

11. Construction apparatus according to claim 1, wherein
a displacement device is provided, by means of which at least one of the two hinges is supported in a longitudinally displaceable manner on the carriage.
